(19) United States
(12) Patent Application Publication
(10) Pub. No.: US 2026/0073014 A1
(43) Pub. Date: Mar. 12, 2026

(54) QUANTUM ENCODING METHODS AND SYSTEMS

(71) Applicant: Hon Hai Precision Industry Co., Ltd., New Taipei City (TW)

(72) Inventors: Yu-Cheng Chen, New Taipei City (TW); Min-Hsiu Hsieh, New Taipei City (TW)

(73) Assignee: Hon Hai Precision Industry Co., Ltd., New Taipei City (TW)

(21) Appl. No.: 19/313,886

(22) Filed: Aug. 29, 2025

Related U.S. Application Data
(60) Provisional application No. 63/692,718, filed on Sep. 10, 2024.

(30) Foreign Application Priority Data
Jun. 13, 2025 (TW) 114122232

(51) Int. Cl. G06F 17/16

(52) U.S. Cl. CPC G06F 17/16

(57) ABSTRACT

Provided are a quantum encoding method and a system to express the electron orbital distribution of electrons in complex molecules as a first Hamiltonian in a binary manner, and to compress the first Hamiltonian into a second Hamiltonian. Not only can it reduce the demand for qubits in circuit design, but it can also be combined with the chemical substrate arrangement to connect the hamming weight of the compressed state with the electronic transition information, so that the chemical experience in searching for low-energy states may be applied to circuit design, and ultimately matched Fixed hamming weights were proposed to complete the final design.

### CROSS-REFERENCE TO RELATED APPLICATION

This application claims the priority benefit of U.S. provisional application Ser. No. 63/692,718, filed on Sep. 10, 2024 and Taiwan application serial no. 114122232, filed on Jun. 13, 2025. The entirety of each of the above-mentioned patent applications is hereby incorporated by reference herein and made a part of this specification.

### BACKGROUND

### Technical Field

The disclosure relates to an encoding method and a system, and particularly relates to a quantum encoding method and a system.

### Related Art

In current chemistry solving processes, universal encoding is typically used to prepare chemistry problems. However, universal encoding methods do not optimize the consumption of qubits. If circuit design methods are applied to chemistry solving, current chemistry problem-related designs mainly focus on two aspects, hardware-friendly and chemistry-inspired. Among the aspects, hardware-friendly approaches do not perform well for chemistry problem solving and cannot achieve target accuracy, while chemistry-inspired algorithms rely all chemistry information on circuit design, resulting in a larger quantum logic gate burden.

From the above, it may be seen that current chemistry universal encoding and circuit design lack synergy and cannot utilize the respective advantages thereof to achieve faster solving processes and less resource consumption.

### SUMMARY

In view of above, the disclosure provides a quantum encoding method and a system that utilizes chemistry characteristics to simplify circuit design and maintain the reasonableness and correctness of obtained solutions.

The disclosure provides a quantum encoding method, which includes the following. A first Hamiltonian of quantized electrons is obtained based on an electron orbital ordering of molecules. A Linear hamming weight preserving encoding module is executed to obtain a second Hamiltonian, in which the size of the second Hamiltonian is smaller than the size of the first Hamiltonian. An optimized electron orbital ordering of molecules is found from a first energy region to a second energy region, in which an energy level of the electron orbitals in first energy region is smaller than an energy level of the second energy region. Also, the weights are connected to the electron orbital which is obtained according to the optimized ordering, and the circuit design is adjusted based on the weights.

The disclosure further provides a quantum encoding system, including a storage and a processor. The storage stores multiple modules. The processor is coupled to the storage and configured to perform the following. A first Hamiltonian of quantized electrons is obtained based on an electron orbital ordering of molecules. A Linear hamming weight preserving encoding module among the multiple modules is executed to obtain a second Hamiltonian, in which the size of the second Hamiltonian is smaller than the size of the first Hamiltonian. An optimized electron orbital ordering of molecules is found from a first energy region to a second energy region, in which an energy level of the electron orbitals in first energy region is smaller than an energy level of the second energy region. Also, the weights are connected to the electron orbital which is obtained according to the optimized ordering, and the circuit design is adjusted based on the weights.

Based on the above, the disclosure, through the quantum encoding method and the system, may express the electron orbital distribution of electrons in complex molecules as a first Hamiltonian in a binary manner, and to compress the first Hamiltonian into a second Hamiltonian. Not only can it reduce the demand for qubits in circuit design, but it can also be combined with the chemical substrate arrangement to connect the hamming weight of the compressed state with the electronic transition information, so that the chemical experience in searching for low-energy states may be applied to circuit design, and ultimately matched Fixed hamming weights were proposed to complete the final design.

### BRIEF DESCRIPTION OF THE DRAWINGS

FIG. 1 is a process schematic diagram of a quantum encoding method of the disclosure.

FIG. 2 is a schematic diagram of a quantum encoding system of the disclosure.

FIG. 3 is a schematic diagram of electrons distributed in electron orbitals of the disclosure.

FIG. 4 is a schematic diagram of hamming weight preserving compression of the disclosure.

### DESCRIPTION OF THE EMBODIMENTS

Reference will now be made in detail to exemplary embodiments of the disclosure, examples of the embodiments are illustrated in the accompanying drawings. Terms such as “first”, “second”, mentioned throughout the specification of the disclosure (including the appended claims) are used to name elements or to distinguish different embodiments or ranges, and are not used to limit the upper or lower limits of the quantity of elements, nor are they used to limit the order of elements. In addition, wherever possible, elements/components using the same reference numerals in the drawings and embodiments represent the same or similar parts.

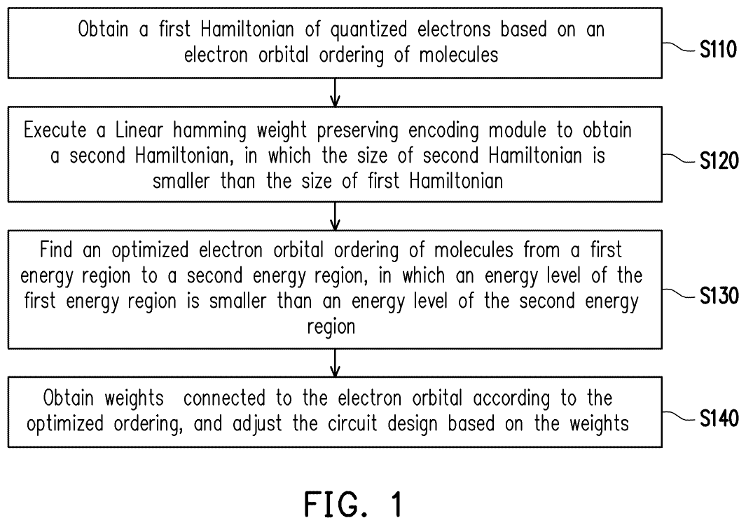

FIG. 1 is a process schematic diagram of a quantum encoding method of the disclosure. In process S110, a first Hamiltonian of quantized electrons is obtained based on an electron orbital ordering of molecules. In process S120, a Linear hamming weight preserving encoding module is executed to obtain a second Hamiltonian, in which the size of second Hamiltonian is smaller than the first Hamiltonian. In process S130, an optimized electron orbital ordering of molecules is found from a first energy region to a second energy region, in which an energy level of the first energy region is smaller than an energy level of the second energy region. In process S140, weights are connected to the electron orbital which is obtained according to the optimized ordering, and the circuit design is adjusted based on the weights.

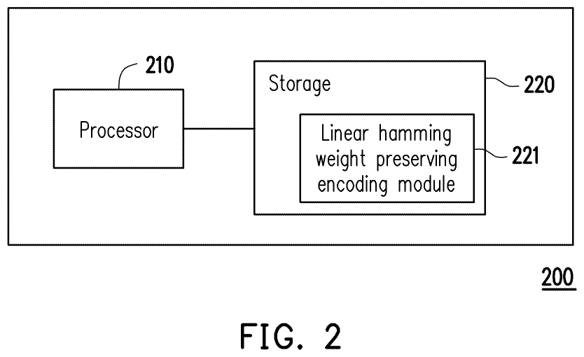

FIG. 2 is a schematic diagram of a quantum encoding system of the disclosure. A quantum encoding system 200 may include a processor 210 and a storage 220.

In the embodiment of the disclosure, the processor is, for example, a central processing unit (CPU), or other programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA), or other similar elements or combinations of the above elements. In the quantum encoding system 200, the processor 210 may be coupled to the storage 220, and the processor 210 may execute various models stored in the storage 220. It should be understood that each process shown in FIG. 1 of the disclosure may be executed by the processor 210.

The storage 220 is, for example, any type of fixed or removable random access memory (RAM), read-only memory (ROM), flash memory, hard disk drive (HDD), solid state drive (SSD) or similar elements or combinations of the above elements, and is used to store multiple models or various application programs that may be executed by the processor 210. In this embodiment, the storage 220 may at least include a Linear hamming weight preserving encoding module 221.

It should be understood that in the electronic configuration of atoms or molecules, electrons in the inner electron orbitals of atoms or molecules are in a relatively stable state. Also, since electrons have two spin directions, when different electrons occupy different orbitals and the orbitals are not filled, different electrons in the same spin direction may also result in lower energy compared to electrons in different spin directions. When the electronic configuration is at lower energy, the stability of atoms or molecules is higher. Therefore, when the processor 210 executes searching for the electronic configuration of atoms or molecules, it will prioritize starting from all electron distribution in inner configurations of relatively lower energy regions and search toward higher energy regions.

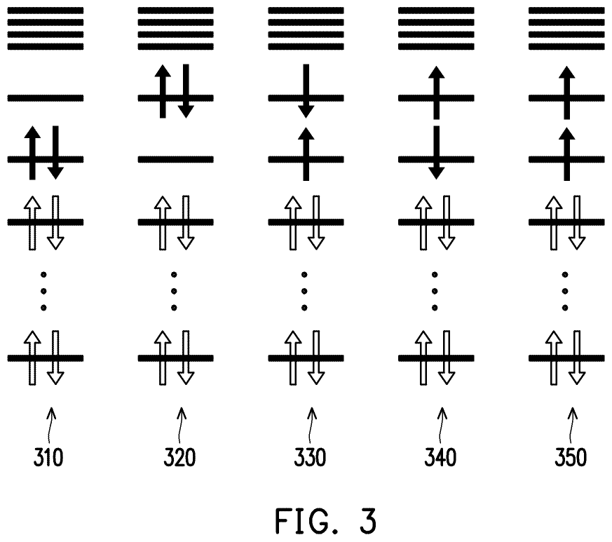

Please refer to FIG. 3, FIG. 3 is a schematic diagram of electron distribution in electron orbitals of the disclosure. In FIG. 3, electrons in the ground state of atoms or molecules are shown as hollow arrows, while solid arrows represent the situation where electrons may be in high-energy electron orbitals. In the embodiment of the disclosure, the processor 210 may convert each electron orbital into binary encoding method, the processor 210 may convert each electron into each 1, and the processor 210 may fill 0 in empty electron orbitals. For example, an electron orbital 310 is converted to 11 . . . 111100, an electron orbital 320 is converted to 11 . . . 110011, an electron orbital 330 is converted to 11 . . . 111001, an electron orbital 340 is converted to 11 . . . 110110, and an electron orbital 350 is converted to 11 . . . 111010. As may be seen from FIG. 3, it illustrates five types of electron distribution patterns in electron orbitals of atoms or molecules. Also, these five electron distribution patterns are the distribution diagrams of the first five most likely electronic configurations of atoms or molecules.

The following further explains the electronic configurations of multiple molecules as shown in Table 1 below.

TABLE 1
Electronic configuration distribution of molecules

| | | | First five electronic | | | |
|---|---|---|---|---|---|---|
| Molecule | (M, N) | Q | configuration | Amplitude | Compressed state | Weight |
| N₂ | (14, 4) | 12 | 11110000000000 | 97.336% | 111100000000 | 4 |
| | | | 00110011000000 | 2.245% | 001100110000 | 4 |
| | | | 11001100000000 | 0.177% | 110011000000 | 4 |
| | | | 11000011000000 | 0.128% | 110000110000 | 4 |
| | | | 11000000001100 | 0.024% | 110000000011 | 4 |
| O₂ | (16, 6) | 14 | 1111011100000000 | 42.256% | 11110111000000 | 6 |
| | | | 1101111100000000 | 20.148% | 11011111000000 | 6 |
| | | | 1111101100000000 | 18.182% | 11111011000000 | 6 |
| | | | 1110111100000000 | 8.670% | 11101111000000 | 6 |
| | | | 0111111001000000 | 1.870% | 01111110010000 | 6 |
| Li₂O | (20, 4) | 15 | 11010100000000000000 | 54.825% | 110101000000000 | 4 |
| | | | 11101000000000000000 | 33.511% | 111010000000000 | 4 |
| | | | 11010000000000000001 | 2.632% | 100001011100000 | 5 |
| | | | 11100100000000000000 | 2.571% | 111001000000000 | 4 |
| | | | 11011000000000000000 | 2.571% | 110110000000000 | 4 |
| LiH | (20, 2) | 10 | 11000000000000000000 | 97.468% | 1100000000 | 2 |
| | | | 00000000000000001100 | 0.352% | 1001010100 | 4 |
| | | | 00000000110000000000 | 0.285% | 0000000011 | 2 |
| | | | 01100000000000000000 | 0.145% | 0110000000 | 2 |
| | | | 10010000000000000000 | 0.145% | 1001000000 | 2 |

In Table 1, (M,N) represents (a quantity of orbitals, a quantity of outer electrons of atoms/molecules), Q represents the quantity after compression, in which Q may be calculated from M and N. Amplitude is, for example, the distribution degree of different electronic configurations of the molecule/atom analyzed through mass spectrometry, and when the amplitude is higher, it represents that the electronic configuration has a higher proportion. In Table 1, the first five electronic configurations (first Hamiltonian) with the highest amplitude are the top five most stable configurations of molecules/atoms. The compressed state (second Hamiltonian) is converted from the binary bit representation method of the first five electronic configurations, where the bit quantity of the compressed state is Q. Weight represents the quantity of Is in the compressed state. It should be understood that unless the compressed bits include 1, the weight should be the same as N.

In Table 1, the first example is for example N₂, whose quantity of orbitals is 14 (M=14), and since the electrons of nitrogen exist in the form of triple bonds, the quantity of unbonded electrons is 4 (N=4). The electronic configuration with the maximum amplitude is 11110000000000, which means all 4 electrons are located in the innermost electron orbitals. When compressed, the compressed state with maximum amplitude is 111100000000, which means the 2 zeros in the outermost electron orbitals are discarded. Since the discarded bits do not include 1, the weight of the compressed state remains 4. In addition, in the other first four electronic configurations of N₂, the outermost electron orbitals are not filled with 1, which means no electrons exist in the outermost electron orbitals, therefore the weights of the compressed states are all 4.

Please continue to refer to Table 1, in the example Li₂O, whose quantity of orbitals is 20 (M=20), and the quantity of unbonded electrons is 4 (N=4). The electronic configuration with the maximum amplitude is 11010100000000000000, which means among the 4 electrons, the innermost electron orbitals include two electrons, and toward the outer layer is a pair of electrons with the same spin direction distributed in different orbitals. When compressed, the compressed state with maximum amplitude is 10101000000000, which means the 5 zeros in the outermost electron orbitals are discarded. Since the discarded bits do not include 1, the weight of the compressed state remains 4. It may be noted that in the electronic configuration 11010000000000000001, the outermost electron orbital is 1, representing that there is 1 electron in the outermost layer. After compression operation, it may be represented by 100001011100000. However, this representation method includes 5 ones, which is not the original weight representation of 4. Since this representation has a difference from the weight before compression, therefore in circuit design solving, this difference may be used to extract it and perform reverse operation to obtain the original electron distribution.

Following the previous paragraph, although partial electron distribution results in the compressed state presenting a different quantity of 1s from before compression, from Table 1 it may be found that more than 89% of the electronic configuration representation methods of example molecules after compression still have the same weight as before compression. This represents that the distribution of electrons mostly falls in regions with relatively low energy (steady state). Therefore, in circuit design solving, only circuits with the quantity of compressed electron orbitals may be configured, without needing to configure circuits with the complete quantity of orbitals, and solutions may still be found.

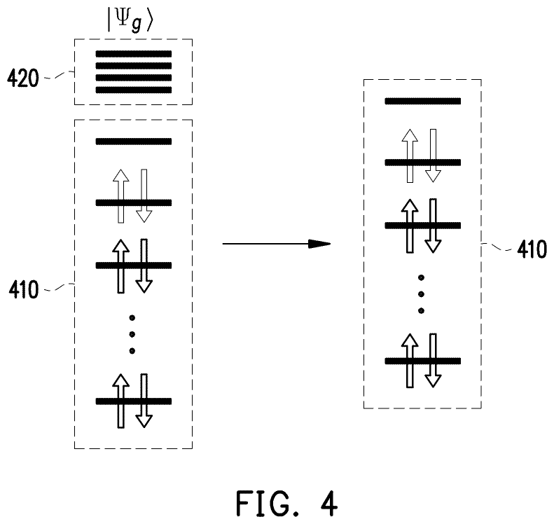

Please refer to FIG. 4, FIG. 4 is a schematic diagram of hamming weight preserving compression of the disclosure. In FIG. 4, an invariant region 410 corresponds to the compressed quantity region, and a compression region 420 is the discarded orbital region. As shown in the drawing, after compression, the remaining invariant region 410 shows the electronic configurations of most example (greater than 89%) molecules.

In the embodiment of the disclosure, the processor 210 may define a linear compression matrix according to the electron orbital ordering and the quantity after compression, in which the first quantity of the first vector of the linear compression matrix is the quantity of orbitals (M), and the second quantity of the second vector of the linear compression matrix is the quantity after compression (Q). Also, the processor 210 may define a first partial matrix and a second partial matrix according to the linear compression matrix, in which the quantity of the first vector of the first partial matrix is the quantity of orbitals subtract the quantity after compression, and the quantity of the second vector of the first partial matrix is the quantity after compression; in which the quantity in the first direction and the quantity in the second direction of the second partial matrix are both quantities after compression, in which the second partial matrix is an identity matrix with diagonal elements of 1.

Specifically, taking N₂ in Table 1 as an example, the linear compression matrix is 14×12 (M×Q). That is to say, the quantity in the first direction of the matrix is 14, and the quantity in the second direction is 12. Next, the first partial matrix defined according to the linear compression matrix is 2×12, and the second partial matrix is 12×12. The first partial matrix is a sparse random matrix, and the sparsity thereof is mainly related to the compression rate. The sparser the matrix, the worse its compression capability, but the smaller the weight (hamming weight) of the compressed state, therefore it is more favorable for circuit design preparation. In addition, the second partial matrix is as follows:

$$Ci = ( \begin{matrix}1 & … & 0 \\ ⋮ & ⋱ & ⋮ \\ 0 & … & 1\end{matrix} )$$

Next, the hamming weight is connected with electron transition, and related circuit design is designed. As aforementioned, when electrons are located in the first Q positions (that is, located in the uncompressed orbital region), the position information thereof is completely preserved. Also, when electrons are located in the latter M subtract Q (M-Q) positions (that is, located in the compressed orbital region), the position information thereof is randomly mapped to the compressed state due to the sparse random matrix. If more electrons are located in the latter M subtract Q positions, then the hamming weight is larger. For example, the second electronic configuration of LiH in Table 1, the compressed hamming weight thereof is 4, which is greater than the original hamming weight 2 with a difference of 2.

According to chemistry experience, in fact, when arranging the chemistry basis from low to high, electrons have a relatively high probability to exist in the low energy region of the first Q positions, and exist in small quantity in the M subtract Q positions. Therefore, during the process of chemistry solving using the embodiment of the disclosure, priority should be given to searching the first Q positions where electrons exist with higher probability, that is, the electron orbital distribution state with lower hamming weight, and then searching and solving toward the electron orbital distribution state with higher hamming weight. Therefore, in the embodiment of the disclosure, in fact fewer circuit resources may be used (taking N₂ as an example, it is not necessary to configure 14 circuit logic gates, but only need to configure 12 circuit logic gates) to achieve the process of chemistry solving.

In the embodiment of the disclosure, the method of searching from the low energy region where electrons are located to the high energy region may be, for example, finding the chemistry space according to the feedback of the variational quantum eigensolver (VQE) model. The energy level where the chemistry space is located is a steady state energy level. That is to say, the processor 210 may find solutions from the low energy region to the high energy region by executing the quantum variational circuit model, in which the state of electrons in the low energy region is more stable compared to the state in the high energy region.

In the embodiment of the disclosure, in response to the distribution situation of electrons of different molecules in the electron orbital, the processor 210 further executes optimization to adjust at least one parameter of the variational quantum eigensolver model, so as to facilitate more efficient searching for solutions when targeting different molecules subsequently.

For example, assuming the electron orbital quantity is 6 and the weight is 2, there are a total of 15 types of electron distribution states: 110000, 101000, 100100, 100010, 100001, 011000, 010100, 010010, 010001, 001100, 001010, 001001, 000110, 000101, 000011. It may compose an equation for searching solutions by giving each electron distribution state a coefficient, and thereby obtain the optimal solution more rapidly by adjusting the coefficients.

In the embodiment of the disclosure, the weight is Weight in Table 1, and is also the hamming weight, which represents the quantity of electrons in the outer layer of the molecule that have not formed bonds.

In the embodiment of the disclosure, although the examples presented in the aforementioned Table 1 are mainly in the form of diatomic molecules or triatomic molecules, and therefore the compressed state of molecules may be obtained by simple theoretical calculation, the method of the disclosure may be applied to, for example, pharmaceutical molecules, energy materials, high-efficiency synthetic chemistry raw materials. The molecular weight that needs to be solved in these fields is relatively large, and therefore through the circuit design and solving by compressing the state of electron orbitals, the distribution of stable electrons of molecules in electron orbitals may be solved more rapidly and accurately, so as to facilitate subsequent use when synthesizing molecules or designing molecules.

In summary, the disclosure, through the quantum encoding method and the system, may express the electron orbital distribution of electrons in complex molecules as a first Hamiltonian in a binary manner, and to compress the first Hamiltonian into a second Hamiltonian. Not only can it reduce the demand for qubits in circuit design, but it can also be combined with the chemical substrate arrangement to connect the hamming weight of the compressed state with the electronic transition information, so that the chemical experience in searching for low-energy states may be applied to circuit design, and ultimately matched Fixed hamming weights were proposed to complete the final design.

What is claimed is:

1. A quantum encoding method, comprising:
obtaining a first Hamiltonian of quantized electrons based on an electron orbital ordering of a molecule;
executing a Linear hamming weight preserving encoding module to obtain a second Hamiltonian, wherein size of the second Hamiltonian is smaller than size of the first Hamiltonian;
finding an optimized electron orbital ordering of the molecule from a first energy region to a second energy region, wherein an energy level of the first energy region is less than an energy level of the second energy region; and
obtaining weights that are connected to the electron orbital according to the optimized ordering, and adjusting circuit design based on the weights.

2. The quantum encoding method as claimed in claim 1, further comprising:
determining a quantity after compression according to a quantity of orbitals of the molecule and a quantity of outer electrons of the molecule.

3. The quantum encoding method as claimed in claim 2, further comprising:
configuring a linear compression matrix according to the electron orbital ordering and the quantity after compression, wherein a first quantity of a first vector of the linear compression matrix is the quantity of orbitals, and a second quantity of a second vector of the linear compression matrix is the quantity after compression.

4. The quantum encoding method as claimed in claim 3, further comprising:
defining a first partial matrix and a second partial matrix according to the linear compression matrix,
wherein a third quantity of a first vector of the first partial matrix is the quantity of orbitals subtract the quantity after compression,
wherein a fourth quantity of a second vector of the first partial matrix is the quantity after compression,
wherein a quantity in a first direction and a quantity in a second direction of the second partial matrix are both quantities after compression,
wherein the second partial matrix is an identity matrix with diagonal elements of 1.

5. The quantum encoding method as claimed in claim 1, wherein finding the optimized electron orbital ordering of the molecule from the first energy region to the second energy region further comprises:
finding a chemistry space according to feedback of a variational quantum eigensolver (VQE) model, wherein an energy level where the chemistry space is located is a steady state energy level.

6. The quantum encoding method as claimed in claim 5, wherein a first state of electrons in the first energy region is more stable compared to a second state of electrons in the second energy region.

7. The quantum encoding method as claimed in claim 5, further comprising:
executing optimization to adjust at least one parameter of the variational quantum eigensolver model.

8. The quantum encoding method as claimed in claim 1, wherein the weight is a quantity of outer electrons of the molecule.

9. The quantum encoding method as claimed in claim 1, further comprising:
expressing the first Hamiltonian and the second Hamiltonian in a binary manner.

10. A quantum encoding system, comprising:
a storage storing a plurality of modules; and
a processor coupled to the storage and configured to:
obtain a first Hamiltonian of quantized electrons based on an electron orbital ordering of a molecule;
execute a Linear hamming weight preserving encoding module among the modules to obtain a second Hamiltonian, wherein size of the second Hamiltonian is smaller than size of the first Hamiltonian;
find an optimized electron orbital ordering of the molecule from a first energy region to a second energy region, wherein an energy level of the first energy region is less than an energy level of the second energy region; and
obtain weights that are connected to the electron orbital according to the optimized ordering, and adjust circuit design based on the weights.

11. The quantum encoding system as claimed in claim 10, wherein the processor is further configured to:
determine a quantity after compression according to a quantity of orbitals of the molecule and a quantity of outer electrons of the molecule.

12. The quantum encoding system as claimed in claim 11, wherein the processor is further configured to:
configure a linear compression matrix according to the electron orbital ordering and the quantity after compression, wherein a first quantity of a first vector of the linear compression matrix is the quantity of orbitals, and a second quantity of a second vector of the linear compression matrix is the quantity after compression.

13. The quantum encoding system as claimed in claim 12, wherein the processor is further configured to:
define a first partial matrix and a second partial matrix according to the linear compression matrix,
wherein a third quantity of a first vector of the first partial matrix is the quantity of orbitals subtract the quantity after compression,
wherein a fourth quantity of a second vector of the first partial matrix is the quantity after compression,
wherein a quantity in a first direction and a quantity in a second direction of the second partial matrix are both quantities after compression,
wherein the second partial matrix is an identity matrix with diagonal elements of 1.

14. The quantum encoding system as claimed in claim 10, wherein the processor is further configured to:
find a chemistry space according to feedback of a variational quantum eigensolver model, wherein an energy level where the chemistry space is located is a steady state energy level.

15. The quantum encoding system as claimed in claim 14, wherein a first state of electrons in the first energy region is more stable compared to a second state of electrons in the second energy region.

16. The quantum encoding system as claimed in claim 14, wherein the processor is further configured to:
execute optimization to adjust at least one parameter of the variational quantum eigensolver model.

17. The quantum encoding system as claimed in claim 10, wherein the weight is a quantity of outer electrons of the molecule.

18. The quantum encoding system as claimed in claim 10, wherein the processor is further configured to:
express the first Hamiltonian and the second Hamiltonian in a binary manner.
